(19) United States
(12) Patent Application Publication
(10) Pub. No.: US 2025/0151796 A1
(43) Pub. Date: May 15, 2025

(54) AEROSOL GENERATING DEVICE

(71) Applicant: NICOVENTURES TRADING LIMITED, London (GB)

(72) Inventors: Dean COWAN, London (GB); Matthew HODGSON, London (GB); Sydney TAVERN, London (GB)

(21) Appl. No.: 18/722,337

(22) PCT Filed: Dec. 19, 2022
(86) PCT No.: PCT/EP2022/086791

§ 371 Date: Jun. 20, 2024

(30) Foreign Application Priority Data
Dec. 22, 2021 (GB) 2118760.4

(51) Int. Cl. A24F 40/465; A24F 7/00; A24F 40/20; H05B 6/10

(52) U.S. Cl. CPC A24F 40/465; A24F 7/00; H05B 6/108; A24F 40/20

(57) ABSTRACT

An aerosol generating device for generating an aerosol from aerosol-generating material is provided. A receptacle is arranged to receive at least a portion of an article containing aerosol-generating material. The receptacle defines a heating zone in which the portion of the article is heated. A stop is arranged to abut an end of the portion of the article received in the receptacle to limit an extent of insertion of the portion of the article into the heating zone. The stop is arranged to move between a first stop position to provide a first usable depth (D1) of the heating zone, and a second stop position to provide a second, different, usable depth (D2) of the heating zone.

### RELATED APPLICATIONS

The present application is a National Phase entry of PCT Application No. PCT/EP2022/086791 filed Dec. 19, 2022, which claims priority to GB Application No. 2118760.4 filed Dec. 22, 2021, each of which is hereby incorporated by reference in their entirety.

### TECHNICAL FIELD

The present invention relates to an aerosol generating device for generating an aerosol from aerosol-generating material. The present invention also relates to an aerosol provision system comprising an aerosol generating device and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an aerosol generating device for generating an aerosol from aerosol-generating material comprising: a receptacle arranged to receive at least a portion of an article containing aerosol-generating material, the receptacle defining a heating zone in which the portion of the article is heated; a stop arranged to abut an end of the portion of the article received in the receptacle to limit an extent of insertion of the portion of the article into the heating zone, wherein the stop is arranged to move between a first stop position to provide a first usable depth of the heating zone, and a second stop position to provide a second, different, usable depth of the heating zone.

The receptacle may comprise a tubular element.

The device may comprise a heating element configured to heat the heating zone, wherein the stop provides a first useable extent of the heating element in the first stop position, and wherein the stop provides a second, different useable extent of the heating element in the second stop position.

The heating element may be configured to be heated to a temperature sufficient to generate aerosol from the aerosol generating material.

The heating element may be elongate.

An axial extent of overlap of the heating element and an article abutting the stop may differ in the first stop position and in the second stop position.

The stop may slide relative to the heating element. The stop may encircle at least part of the heating element.

The stop may be movable in the receptacle.

The receptacle and the heating element may be fixedly mounted.

The stop may define an end wall. The end wall may abut the article.

The receptacle may comprise an end wall and the stop may protrude from the end wall.

The stop may comprise a movable member upstanding from the end wall.

The receptacle may comprise a peripheral wall and a movable member. The movable member may protrude from the peripheral wall in the second stop position and may be at least one of retracted to and retracted from the peripheral wall in the first stop position.

The stop may comprise at least one of a movable piston, a movable rod, and a movable sleeve. The stop may be telescopic.

The device may comprise an actuator configured to actuate the stop.

The actuator may comprise a rotary collar.

The actuator may comprise a sliding button.

The actuator may comprise a slider.

The actuator may be configured to provide linear actuation of the stop.

The device may comprise a heating assembly wherein the heating assembly may comprise an inductor coil and the inductor may be configured to generate a varying magnetic field.

The coil may extend around the receptacle.

The inductor coil and the heating element may be fixedly mounted.

The heating element may protrude into the heating zone. The heating element may comprise a wall of the heating zone.

The device may comprise a primary body wherein the primary body comprises the receptacle and the stop; a first auxiliary body removably mountable to the primary body comprising a first chamber arranged to receive at least a portion of an article containing aerosol-generating material; and a second auxiliary body removably mountable to the primary body comprising a second chamber arranged to receive at least a portion of an article containing aerosol-generating material, wherein the first auxiliary body and second auxiliary body are arranged to be interchangeably attached to the primary body; and wherein the first chamber has a first configuration and the second chamber has a second configuration, the first configuration being different to the second configuration such that the portion of an article receivable by the first chamber is different than the portion receivable by the second chamber.

The first auxiliary body may be a mouthpiece and the second auxiliary body may be a mouthpiece.

According to an aspect, there is provided an aerosol generating device for generating an aerosol from aerosol-generating material, the aerosol generating device comprising: a heating chamber arranged to receive at least a portion of an article containing aerosol-generating material; a heating element arranged to axially overlap at least a portion of an article received in the heating chamber; and a stop arranged to abut an end of a portion of an article received in the heating chamber, the stop being movable to adjust the extent of axial overlap of an article received in the heating chamber and the heating element.

According to an aspect, there is provided an aerosol generating system is comprising: an article comprising aerosol-generating material; and an aerosol generating device for generating an aerosol from aerosol-generating material comprising a receptacle arranged to receive at least a portion of an article containing aerosol-generating material, the receptacle defining a heating zone in which the portion of the article is heated, a stop arranged to abut an end of a portion of the article received in the receptacle to limit an extent of insertion of the portion of the article into the heating zone, wherein the stop is arranged to move between a first stop position to provide a first usable depth of the heating zone, and a second stop position to provide a second, different, usable depth of the heating zone.

The article may be a consumable.

### BRIEF DESCRIPTION OF THE DRAWINGS

Embodiments will now be described, by way of example only, and with reference to the accompanying drawings in which:

FIG. 1 shows schematically an aerosol generating system with an aerosol generating device and an article inserted into the device;

FIG. 2A shows schematically part of the aerosol generating system of FIG. 1 with the aerosol generating device in a first configuration;

FIG. 2B shows schematically part of the aerosol generating system of FIG. 1 with the aerosol generating device in a second configuration;

FIG. 3A shows schematically part of an aerosol generating system with the aerosol generating device in a first configuration;

FIG. 3B shows schematically the part of the aerosol generating system of FIG. 3A with the aerosol generating device in a second configuration;

FIG. 4A shows schematically part of an aerosol generating system with the aerosol generating device in a first configuration; and

FIG. 4B shows schematically the part of the aerosol generating system of FIG. 4A with the aerosol generating device in a second configuration.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol generating material may include any plant-based material, such as tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt% or 70 wt % of amorphous solid, to about 90 wt %, 95 wt% or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

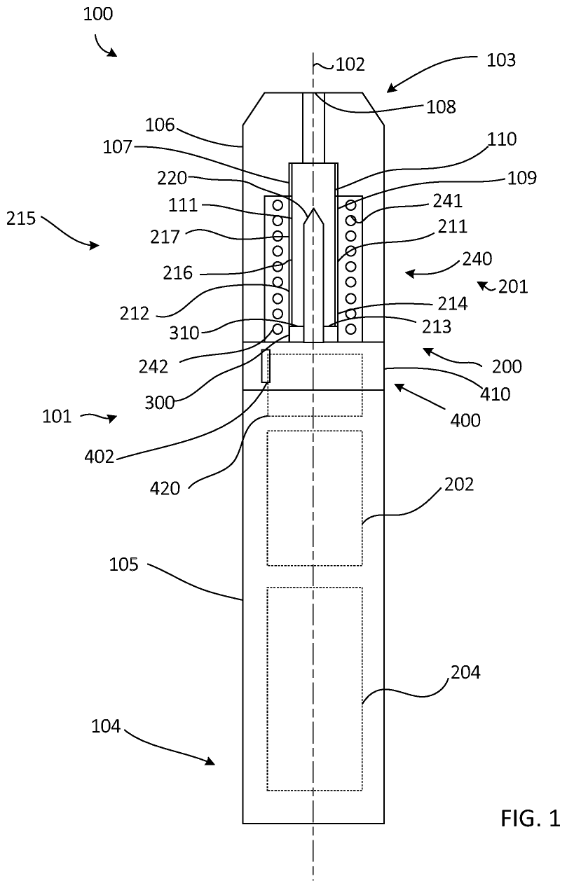

FIG. 1 shows an example of an aerosol generating system 100. The system 100 comprises an aerosol generating device 101 for generating aerosol from an aerosol generating material, and a replaceable article 110 comprising the aerosol generating material. The device 101 can be used to heat the replaceable article 110 comprising the aerosol generating material, to generate an aerosol or other inhalable material which can be inhaled by a user of the device 101. The article 110 may be fully or partially inserted into the device 101 for heating by the device 101.

The device 101 defines a longitudinal axis 102, along which an article 110 may extend when inserted into the device 101. In use, a user draws on the aerosol generated in the device. This causes the aerosol to flow through the article 110 along a flow path towards a proximal end 103 of the device 101. The proximal end (or mouth end) 103 of the device 101 is the closest to the mouth of the user when device 101 is in use. The other end of the device 101, furthest away from the proximal end 103, is known as the distal end 104 of the device 101 because, in use, it is the end furthest away from the mouth of the user.

As a user draws on the aerosol generated in the device, the aerosol flows in a direction towards the proximal end of the device 101. The terms proximal and distal as applied to features of the device 101 will be described by reference to the relative positioning of such features with respect to each other in a proximal-distal direction along the axis 102.

The device 101 comprises a primary body 105 and an auxiliary body 106. The auxiliary body 106 is removably attachable to the primary body 105. In embodiments, the primary body 105 and the auxiliary body 106 form a single unit. The primary body 105 comprises a housing, which surrounds and houses various components of the device 101. The housing is elongate. The device 101 defines an article receiving chamber 109. The article receiving chamber 109 is arranged to receive at least a portion of the article 110. In the embodiment shown in FIG. 1, the article receiving chamber 109 is sized to enclose the article 110. In embodiments, the article 110 is arranged to protrude from the article receiving chamber 109. The article receiving chamber 109 is defined in both of the primary body 105 and the auxiliary body 106. In embodiments, the article receiving chamber 109 is defined in the primary body 105 only.

The auxiliary body 106 comprises an auxiliary receiving chamber 107 arranged to receive at least a portion of the article 110. The article 110 is sized to be received by the auxiliary receiving chamber 107. The auxiliary receiving chamber 107 forms part of the article receiving chamber 109. The auxiliary receiving chamber 107 is generally cylindrical in shape. However, other shapes would be possible. The auxiliary receiving chamber 107 is aligned along the longitudinal axis 102 of the device 101. The auxiliary body 106 is located at the proximal end 103 of the device 101.

As shown on FIG. 1, the auxiliary body 106 is a mouthpiece. An opening 108 is formed in the mouthpiece at the proximal end 103 of device 101. The opening 108 is aligned on the longitudinal axis 102. The opening 108 is fluidly connected to the auxiliary receiving chamber 107 such that aerosol flows through the article 110, partially received in the auxiliary receiving chamber 107, through the opening 108 towards the proximal end 103 of the device 101. In use of the device 101, the mouthpiece is detached from the primary body 105 prior to the article 110 being inserted into the auxiliary receiving chamber 107. In some embodiments, the article 110 is inserted through opening 108 into the auxiliary receiving chamber 107. In embodiments, the auxiliary body is omitted or is integrally formed with the primary body 105.

The device 101 is configured such that a variety of different auxiliary bodies 106 can be used interchangeably with the device 101. In the present embodiment, the device comprises a first auxiliary body 106 (shown in FIG. 1) and a second auxiliary body 106 (not shown). The first auxiliary body comprises a first auxiliary chamber arranged to receive at least a portion of the article 110. The second auxiliary comprises a second auxiliary chamber arranged to receive at least a portion of an article 110. The first auxiliary chamber has a first configuration and the second auxiliary chamber has a second configuration, the first configuration being different to the second configuration such that a portion of the article 110 receivable by the first auxiliary chamber is different than the portion receivable by the second chamber. Such a different configuration may include one or more of chamber depth, chamber width, and chamber shape.

The device 101 includes an apparatus for heating aerosol-generating material 200. The apparatus 200 includes a heating assembly 201, a controller (control circuit) 202, and a power source 204. The apparatus 200 forms part of the primary body 110. The apparatus 200 may include a chassis and other components forming part of the device 101. The heating assembly 201 is configured to heat the aerosol-generating material of an article 110 inserted into the device 101, such that an aerosol is generated from the aerosol generating material. The power source 204 supplies electrical power to the heating assembly 201, and the heating assembly 201 converts the supplied electrical energy into heat energy for heating the aerosol-generating material. The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 204 may be electrically coupled to the heating assembly 201 to supply electrical power when required and under control of the controller 202 to heat the aerosol generating material. The control circuit 202 may be configured to activate and deactivate the heating assembly 201 based on a user input.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating chamber 211 configured and dimensioned to receive the article 110 to be heated. The heating chamber defines at least part of the article receiving chamber 109. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes a peripheral wall 214. The receptacle 212 in embodiments is a one-piece component.

The heating chamber 211 is defined by the receptacle 212. The receptacle 212 acts as a support member. The receptacle 212 comprises a generally tubular member. The receptacle 212 extends along and around and is substantially coaxial with the longitudinal axis 102 of the device 101. However, other shapes would be possible. The receptacle 212 (and so heating zone 215) is open at its proximal end such that an article 110 can be received by the heating chamber 211 therethrough. The receptacle 212 may comprise one or more conduits that form part of an air path.

As shown on FIG. 1, the auxiliary receiving chamber 107 of the auxiliary body 106 and the heating chamber 211 are axially aligned. The auxiliary receiving chamber 107 acts a continuation of heating chamber 211 when the auxiliary body 106 is attached to the primary body 105. The inner dimensions of the auxiliary receiving chamber 107 perpendicular to longitudinal axis 102 substantially correspond to the inner dimensions of the chamber 211 perpendicular to longitudinal axis 102. The auxiliary receiving chamber 107 may guide insertion of article 110 into the heating chamber 211.

The receptacle 212 is formed free of material that is heatable by penetration with a varying magnetic field. The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 101. The receptacle 212 may be formed from a rigid material to aid support of other components. In embodiments, however, the receptacle 212 comprises material that is heatable by penetration with a varying magnetic field.

As illustrated in FIG. 1, the heating assembly 201 comprises a heating element 220. The heating element 220 is configured to heat the heating zone 215. The heating zone 215 is defined in the heating chamber 211. In embodiments the heating chamber 211 defines a portion of the heating zone 215 or the extent of the heating zone 215.

The heating element 220 is heatable to heat the heating zone 215. The heating element 220 is an induction heating element. That is, the heating element 220 comprises a susceptor that is heatable by penetration with a varying magnetic field. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240. The magnetic field generator 240 is configured to generate one or more varying magnetic fields that penetrate the susceptor so as to cause heating in the susceptor. The magnetic field generator 240 includes an inductor coil arrangement 241. The inductor coil arrangement 241 comprises an inductor coil 242, acting as an inductor element. The inductor coil 242 is a helical coil, however other arrangements are envisaged. In embodiments, the inductor coil arrangement 241 comprises two or more inductor coils 242. The two or more inductor coils in embodiments are disposed adjacent to each other and may be aligned co-axially along the axis.

In some examples, in use, the inductor coil is configured to heat the heating element 220 to a temperature of between about 200° C. and about 350° C., such as between about 240° C. and about 300° C., or between about 250° C. and about 280° C.

The heating element 220 extends in the heating zone 215. The heating element 220, acting as a protruding element, protrudes in the heating zone 215. The heating element 220 upstands from a distal end of the receptacle 212. In embodiments, the distal end of the receptacle 212 is defined by an end wall 213. The heating element 220 is spaced from the peripheral wall 214. The heating assembly 201 is configured such that when an article 110 is received by the heating chamber 211, a portion of the heating element 220 extends into a distal end of the article 110. The portion of the heating element 220 extending into the distal end of the article 110 defines an axial extent of overlap of the heating element 220 and the article 110. The heating element 220 is positioned, in use, within the article 110. The heating element 220 is configured to heat aerosol generating material of an article 110 from within, and for this reason is referred to as an inner heating element.

The heating element 220 extends into the heating chamber 211 from the distal end of the heating chamber 211 along the longitudinal axis 102 of the device (in the axial direction). In embodiments, the heating element 220 extends into the heating chamber 211 spaced from the axis 102. The heating element 220 may be off-axis or non-parallel to the axis 102. Although one heating element 220 is shown, it will be understood that in embodiments, the heating assembly 201 comprises a plurality of heating elements 220. Such heating elements in embodiments are spaced from but parallel to each other.

The inductor coil 241 is disposed external to the heating chamber 211. The inductor coil 241 encircles the heating zone 215. The inductor coil 241 extends around at least a portion of the heating element 220. The helical inductor coil 241 is configured to generate a varying magnetic field that penetrates the heating element 220. The heating element 220 acts as a susceptor. The helical inductor coil 241 is arranged coaxially with the heating chamber 211 and longitudinal axis 102.

The inductor coil 242 is a helical coil comprising electrically-conductive material, such as copper. The coil is formed from wire, such as Litz wire, which is wound helically around a support member. The support member is formed by the receptacle 212 or by another component. In embodiments, the support member is omitted. The support member is tubular. The coil 242 defines a generally tubular shape. The inductor coil 242 has a generally circular profile. In other embodiments, the inductor coil 242 may have a different shape, such as generally square, rectangular or elliptical. The coil width may increase or decrease along its length.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximised. By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, the inductor coil, or each inductor coil, may have substantially the same or different values of inductance, axial lengths, radii, pitches, numbers of turns, etc.

FIG. 1 shows the article 110 received in the device 101. The article 110 is sized to be received by the receptacle 212. The outer dimensions of the article 110 perpendicular to the longitudinal axis of the article 110 substantially correspond with the inner dimensions of the chamber 211 perpendicular to the longitudinal axis 102 of the device 101 to allow insertion of the article 110 into the receptacle 212.

In embodiments, a gap 216 is defined between an outer side 111 of the article 110 and an inner side 217 of the receptacle 212. The gap 216 may act as an air passage along at least part of the axial length of the chamber 211. The axial length of the article is the distance between an insertion end 112 of article 110 and a proximal end of article 110. The insertion end 112 of the article 110 is arranged to contact a base when the article is inserted in the receptacle 212.

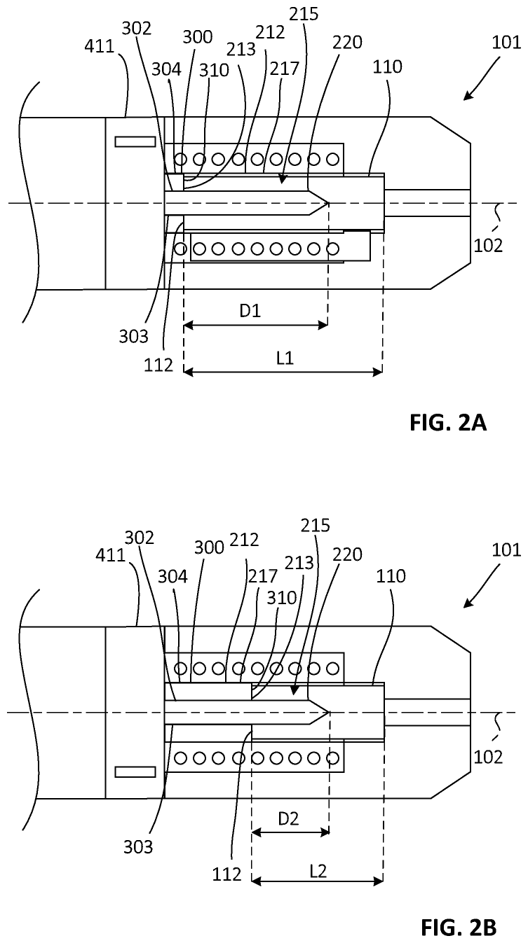

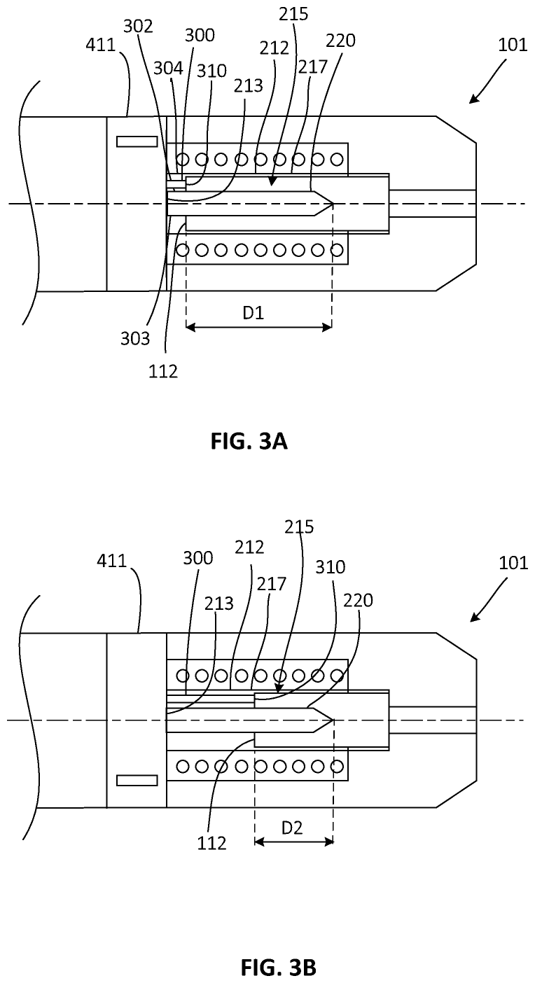

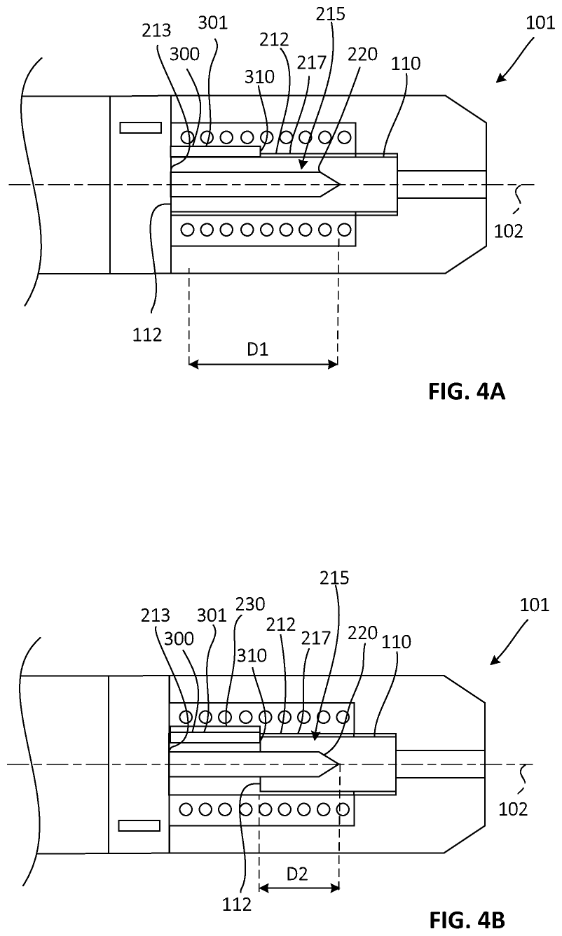

The heating assembly 201 further comprises a stop 300. The stop 300 is moveable in the receptacle 212. The stop 300 is in the receptacle 212. In embodiments, for example as shown in FIGS. 1, 2a and 2b, the stop 300 defines an end wall 213. The end wall 213 defines the base. The stop 300 acting as the end wall 213 is movable relative to the receptacle 212. In embodiments, for example as shown in FIGS. 3a, 3b, 4a, and 4b, the receptacle 212 comprises the end wall 213, and the stop 300 defines the base. The stop 300 is movable relative to the end wall.

The stop 300 is formed free of material that is heatable by penetration with a varying magnetic field. The stop 300 may be formed from an insulating material. For example, the stop 300 may be formed from a plastic, such as polyether ether ketone (PEEK). Other suitable materials are possible. Using a non-metallic material for the stop 300 may assist with restricting heating of other components of the device 101 and/or with preventing burning of the aerosol generating material.

The device 101 includes an actuation assembly 400. The actuation assembly 400 comprises a user-operable actuation element 410 and an actuation mechanism 420. The actuation element 410 is configured to adjust the device 101 for use with the dimensions of a selected article 110 to be received by the device. In the embodiment of FIG. 1, the actuation element 410 comprises a rotary collar 411. In other embodiments, the actuation element 410 may have a different configuration, for example may comprise at least one of a button, a sliding button, a slider and a switch. The actuation mechanism 420 is mechanically or electrically connected to the actuation element 410. The actuation mechanism 420 may be an actuator or an electric motor. The actuation mechanism 420 is configured to move stop 300 in relation to receptacle 212 in response to actuation element 410 being operated. The actuation mechanism 420 is configured to move stop 300 to adjust the usable extent of the heating zone 215. That is, the extent to which the article may be inserted into the heating zone 215.

The actuation assembly 400 further comprises an indicator element 402. In some embodiments, the indicator element may be omitted. The indicator element 402 provides visual indication to a user about the position of the stop 300 in relation to the receptacle 212. The indicator element 402 is shown as a raised element but may instead comprise a notch, a marking or a light.

As shown in FIG. 2A, the stop 300 is generally tubular. The stop 300 protrudes in the receptacle 212. The stop 300 acts as the end wall 213. The stop 300 comprises a stop surface 310. The stop surface 310 acts as the base. The stop surface 310 faces the open proximal end of the receptacle 212. The stop 300 closes the receptacle 212 at its distal end. The stop 300 comprises an inner surface 303 and an outer surface 304. The stop surface 310 is configured to abut an insertion end 112 of the article 110. The stop 300 limits the extent of insertion of the article 110 into the heating zone 215.

The stop 300 is sized to be received in receptacle 212. The outer dimensions of stop 300, perpendicular to the longitudinal axis 102 of the device, substantially correspond with the inner dimensions of receptacle 212. The outer surface 304 of stop 300 and the inner side 217 of the receptacle 212 form a slide fit.

The stop 300 encircles a portion of heating element 220. The inner surface of stop 300 defines a bore 302. The bore 302 extends along the longitudinal axis 102 of the device 101. The bore 302 is sized to receive the heating element 220. The bore 302 and the heating element 220 are complimentary sized to form a slide fit. The inner surface 303 may be in contact with the outer surface of the heating element 220. The stop 300 encircles a portion of the heating element 220 to reduce the usable depth D1 of the heating zone 215. The usable depth of heating zone 215 is defined as a portion of the heating zone 215 which is available to receive a portion of the article 110 to be heated by the heating element 220.

The stop 300 is arranged to move between a first stop position to provide a first usable depth D1 of the heating zone 215, and a second stop position to provide a second, different, usable depth D2 of the heating zone 215. Advantageously, adjusting the usable depth of the heating zone 215, allows for articles of varying lengths to be used with device 101 and/or for different lengths of portions of aerosol generating material in an article to be used with the device 101.

The stop 300 is movable relative to receptacle 212 and the heating element 220. The receptacle 212 and the heating element 220 are in a fixed position. The stop 300 slides over the outer surface of heating element 220. In the example of FIGS. 2A and 2B, the stop 300 moves from the first stop position to the second stop position along the longitudinal axis 102 of device 101. The first stop position and the second stop position are different axial positions of the stop 300.

FIG. 2A shows the device 101 receiving an article 110 having first pre-determined dimensions. The first pre-determined dimensions may correspond to a first axial length L1 of the article 110. The stop 300 is shown in the first stop position. In the first stop position, the stop 300 provides a first useable depth D1 of the heating zone 215. In the first stop position, the stop 300 overlaps a first portion of the heating member 220.

FIG. 2B shows the device 101 receiving an article 110 having second pre-determined dimensions. The second pre-determined dimensions may correspond to a second axial length L2 of the article 110. The stop 300 is shown in the second stop position. In the second stop position, the stop 300 provides a second useable depth D2 of the heating zone 215. The second usable depth D2 of the heating zone 215 is different to the first usable depth D1. In the second stop position, the stop 300 overlaps a second portion of heating member 220. The second portion of heating member 220 is different in length to the first portion. The axial extent of overlap of the heating element 220 and the article 110 abutting the stop 300 differs in the first stop position and in the second stop position.

The rotary collar 411, acting as an actuator, is illustrated as having a first circumferential position, and a second circumferential position. FIG. 2A shows the rotary collar 410 in the first circumferential position and FIG. 2B shows the rotary collar 410 in the second circumferential position. When the rotary collar 411 is in the first circumferential position, the stop 300 is in the first stop position. When the rotary collar 411 is in the second circumferential position, the stop 300 is in the second stop position. Moving the rotary collar 411 from the first circumferential position to the second circumferential position causes the stop 300 to move from the first stop position to the second stop position. Moving the rotary collar 411 from the second circumferential position to the first circumferential position causes the stop 300 to move from the second stop position to the first stop position. In the present embodiment, the rotary collar 411 is shown as having two circumferential positions. In other embodiments, the rotary collar 411 may have three or more circumferential positions each corresponding to a stop position of stop 300. The actuator in embodiments is arranged to adjust the stop between a predetermined number of discrete positions, or is continuously variable across the range of movement of the stop 300.

The first stop position of stop 300 is pre-determined so as to configure the device 101 to receive an article 110 having a first length L1. The second stop position of stop 300 is pre-determined so as to configure the device 101 to receive an article 110 having a second length L2, different to the first length L1. In some embodiments, the first stop position of stop 300, is pre-determined to provide a first axial extent of overlap of the heating element 220 and an article 110 abutting the stop 300. The second stop position of stop 300 is pre-determined to provide a second axial extent of overlap of the heating element 220 and an article 110 abutting the stop 300. The first axial extent of overlap is different to the second axial extent of overlap.

In use of the device 101, prior to inserting an article 110 into the device 101, a user moves the rotary collar 411 to the first circumferential position or to the second circumferential position to configure the device 101 for use with a first article having a first length L1 or a second article having a second length L2 respectively. As a result, actuation mechanism 420 moves the stop 300 to the first stop position or to the second stop position respectively. The user then insert the corresponding first or second article into the device until the insertion end 112 abuts the stop 300. In some embodiments, the overall lengths of the first and second article may be substantially the same but the first article may have a first length of aerosol generation material and the second article may have a second, different length of aerosol generating material.

The stop 300 in embodiments has different configurations. In the embodiment described with reference to FIGS. 3A and 3B, the stop 300 is a pin or a protruding member. Other configurations such as a sleeve, rod, and tubular member may be used. The arrangement of the device 101 is generally the same as described above and so a detailed description will be omitted. Stop 300 extends from the end wall 213 of receptacle 212. The stop comprises an outer surface 304 and a stop surface 310. The stop surface 310 is configured to abut the insertion end 112 of the article 110. The stop 300 is spaced apart from the inner surface 217 of receptacle 212 and from the heating element 220. The stop 300 is arranged to move between a first stop position to provide a first usable depth D1 of the heating zone 215, and a second stop position to provide a second, different, usable depth D2 of the heating zone 215. In the example of FIGS. 3A and 3B, a stop 300 is shown as a single member although other configurations are envisaged. For example, stop 300 may comprise a plurality of pins arranged circumferentially around the heating element 220. In embodiments, one of the stop positions of the stop 300 is the stop being retracted to or retracted from the end wall 213 such that the insertion end 112 of the article 110 abuts the end wall 213, and so the end wall 213 acts to limit insertion of the article 110. In other words, when the stop 300 is retracted to or retracted from the end wall 213 of receptacle 212, the end wall 213 acts as the base.

In the embodiment described with reference to FIGS. 4A and 4B, the stop 300 comprises a moveable element 301 configured to move radially in relation to the longitudinal axis 102 of the device. The arrangement of the device 101 is generally the same as described above and so a detailed description will be omitted. The stop 300 protrudes from peripheral wall 214 of receptacle 212. The stop 300 moves between a first and a second stop position along a direction perpendicular to the longitudinal axis 102 of the device 101. The first and second stop positions are different radial positions of the stop 300. The stop 300 moves in relation to the receptacle 212 and the heating element 220.

FIG. 4A shows the stop 300 in the first position and FIG. 4B shows the stop 300 in the second position. When in the first stop position, the stop 300 provides a first usable depth D1 of the heating zone 215. When in the second stop position, the stop 300 provides a second, different, usable depth D2 of the heating zone 215. In the first stop position, the stop 300 abuts the insertion end 112 of article 110. In the second stop position, the stop 300 is retracted from the receptacle 212. In the second position, the insertion end 112 of the article 110 abuts the end wall 213 of the receptacle 212.

As shown in FIGS. 4A and 4B, the heating chamber 211 comprises a recess 230. The recess 230 is formed on the inner surface 217 of receptacle 212. The recess 230 is sized to receive stop 300. In the second stop position, the stop 300 is received in the recess 230 such that it does not limit the extent of insertion of article 110. The stop surface 310 of stop 300 is not in contact with insertion end 112 of the article 110.

In the embodiment of FIGS. 4A and 4B, the stop 300 is a blade. However it will be understood that other configurations may be used such as one or more of a pin, a protrusion and a tab. Although the stop 300 is shown as a single element, in embodiments, the stop 300 may comprises a plurality of elements. For example, stop 300 may comprise a plurality of pins arranged circumferentially around the heating element 220.

In embodiments, at least part of the peripheral wall 214 of the receptacle 212 is defined by the heating element. The heating element is configured to receive the article 110. The heating element is generally tubular. The stop 300 is sized to be received in the heating element. The outer dimensions of stop 300, perpendicular to the longitudinal axis 102 of the device, may substantially correspond with the inner dimensions of heating element 220. The heating element is configured to heat aerosol generating material of the article 110 from the outside, and for this reason is referred to as an outer heating element.

In embodiments, the device 101 is generally the same as described in relation to FIGS. 2A and 2B. However, the stop surface 310 of stop 300 is retracted to or from the end wall 213 of receptacle 212 in the first stop position. In the first stop position, the end wall 213 defines the usable extent of the heating zone 215. When the stop 300 is moved to a second stop position, the stop 300 defines the usable extent of the heating zone 215.

In the above described embodiments, the heating arrangement is an inductive heating arrangement. In embodiments, other types of heating arrangement are used, such as resistive heating. The configuration of the device is generally as described above and so a detailed description will be omitted. In such arrangements the heating assembly comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol generating device for generating an aerosol from aerosol-generating material comprising:
a receptacle arranged to receive at least a portion of an article containing aerosol-generating material, the receptacle defining a heating zone in which the portion of the article is heated,
a stop arranged to abut an end of the portion of the article received in the receptacle to limit an extent of insertion of the portion of the article into the heating zone;
wherein the stop is arranged to move between a first stop position to provide a first usable depth of the heating zone, and a second stop position to provide a second, different, usable depth of the heating zone.

2. The device of claim 1, comprising a heating element configured to heat the heating zone,
wherein the stop provides a first useable extent of the heating element in the first stop position; and
wherein the stop provides a second, different useable extent of the heating element in the second stop position.

3. The device of claim 2, wherein an axial extent of overlap of the heating element and an article abutting the stop differs in the first stop position and in the second stop position.

4. The device of claim 2, wherein the stop slides relative to the heating element.

5. The device of claim 2, wherein the stop encircles at least part of the heating element.

6. The device of claim 1, wherein the stop is movable in the receptacle.

7. The device of claim 1, wherein the stop defines an end wall.

8. The device of claim 1, wherein the receptacle comprises an end wall and wherein the stop protrudes from the end wall.

9. The device of claim 8, wherein the stop comprises a movable member upstanding from the end wall.

10. The device of claim 1, wherein the receptacle comprises a peripheral wall and the stop comprises a movable member; and
wherein the movable member protrudes from the peripheral wall in the second stop position and is at least one of retracted to and retracted from the peripheral wall in the first stop position.

11. The device of claim 1, wherein the stop comprises at least one of a movable piston, a movable rod, and a movable sleeve.

12. The device of claim 1, comprising an actuator configured to actuate the stop.

13. The device of claim 12, wherein the actuator comprises a rotary collar.

14. The device of claim 1, comprising a heating assembly wherein the heating assembly comprises an inductor coil and the inductor coil is configured to generate a varying magnetic field.

15. The device of claim 14, wherein the inductor coil extends around the receptacle.

16. The device of claim 1, further comprising:
a primary body wherein the primary body comprises the receptacle and the stop;
a first auxiliary body removably mountable to the primary body comprising a first chamber arranged to receive at least a portion of an article containing aerosol-generating material; and
a second auxiliary body removably mountable to the primary body comprising a second chamber arranged to receive at least a portion of an article containing aerosol-generating material;
wherein the first auxiliary body and second auxiliary body are arranged to be interchangeably attached to the primary body;
wherein the first chamber has a first configuration and the second chamber has a second configuration, the first configuration being different to the second configuration such that the portion of an article receivable by the first chamber is different than the portion receivable by the second chamber.

17. The device of claim 16, wherein the first auxiliary body is a mouthpiece and wherein the second auxiliary body is a mouthpiece.

18. An aerosol generating device for generating an aerosol from aerosol-generating material, the aerosol-generating device comprising:
a heating chamber arranged to receive at least a portion of an article containing aerosol-generating material,
a heating element arranged to axially overlap at least a portion of an article received in the heating chamber, and
a stop arranged to abut an end of a portion of an article received in the heating chamber,
the stop being movable to adjust the extent of axial overlap of an article received in the heating chamber and the heating element.

19. An aerosol generating system comprising
an article comprising aerosol-generating material; and
an aerosol generating device according to claim 1.

20. The aerosol-generating system of claim 19, wherein the article is a consumable.
